(19) United States
(12) Patent Application Publication
(10) Pub. No.: US 2011/0214063 A1
(43) Pub. Date: Sep. 1, 2011

(54) EFFICIENT NAVIGATION OF AND INTERACTION WITH A REMOTED DESKTOP THAT IS LARGER THAN THE LOCAL SCREEN

(75) Inventor: Elton Saul, Kirkland, WA (US)

(73) Assignee: Microsoft Corporation, Redmond, WA (US)

(21) Appl. No.: 12/715,030

(22) Filed: Mar. 1, 2010

(51) Int. Cl. G06F 3/01; G06F 3/048

(52) U.S. Cl. 715/740; 715/800; 715/786

(57) ABSTRACT

Techniques are disclosed for the efficient navigation of and interaction with a remoted desktop that is larger than the local viewing area. In an embodiment, a client displays both a portion of the remoted desktop in its native size, as well as a “mini-map”—a scaled-down view of the entire remoted desktop that may be used for navigation of the natively displayed portion of the remoted desktop. In an embodiment, the natively displayed portion of the remoted desktop is indicated in the mini-map. In an embodiment, use of a computer mouse and/or multi-touch gestures is used as input to navigate the natively displayed portion of the remoted desktop.

### BACKGROUND OF THE INVENTION

Although computers were once isolated and had minimal or little interaction with other computers, computers now interact with a wide variety of other computers through Local Area Networks (LANs), Wide Area Networks (WANs), dial-up connections, and the like. With the wide-spread growth of the Internet, connectivity between computers has become more important and has opened up many new applications and technologies. The growth of large-scale networks, and the wide-spread availability of low-cost personal computers, has fundamentally changed the way that many people work, interact, communicate, and play.

One increasing popular form of networking may generally be referred to as remote presentation systems, which can use protocols such as Remote Desktop Protocol (RDP), Independent Computing Architecture (ICA), and others to share a desktop and other applications with a remote client. Such computing systems typically transmit the keyboard presses and mouse clicks or selections from the client to a server, relaying the screen updates back in the other direction over a network connection (e.g., the Internet). As such, the user has the experience as if their machine is executing the applications locally, when in reality the client device is only sent screenshots of the applications as they appear on the server side.

In some circumstances, a screen to be displayed across a remote presentation session (referred to herein as a “remoted desktop”) is larger than the viewable area on the client. For instance, a 1600×1200 pixel desktop may be remoted, and then viewed either on a 1024×768 pixel display or a window that occupies a portion of that 1024×768 pixel display. To display the remoted desktop in its actual size requires showing only a portion of it, and providing scrollbars to navigate to the undisplayed portion. To display the entire desktop requires shrinking the graphics (“scaled-down graphics”).

Both of these techniques are tedious and disrupt a user's work flow. Further, in the former case, where a user has navigated to one portion of the remoted desktop, he is unable to see those un-displayed portions of the desktop, and thus, unaware when events occur there.

Further, a problem with using scroll bars to navigate is that it is a linear operation—the user cannot jump to a specific portion of the remoted desktop.

While scaled-down graphics allow a user to view the entire remoted desktop at once, interaction with the scaled-down graphics may be difficult due to their smaller size.

Another common situation that reflects these issues may involve a remoted desktop that spans multiple monitors on the server, wherein the client has only a single monitor with which to display that remoted desktop.

### SUMMARY OF THE INVENTION

In view of these problems, it would be an improvement to provide techniques for improved navigation of and interaction with a remoted desktop that is larger than the client display area.

In an embodiment, a client displays both a portion of the remoted desktop in its native size, as well as a “mini-map”—a scaled-down view of the entire remoted desktop that may be used for navigation of the natively displayed portion of the remoted desktop. In an embodiment, the portion of the remoted desktop that is natively displayed is indicated in the mini-map.

In an embodiment, use of a computer mouse and/or multi-touch gestures is used as input to navigate the natively displayed portion of the remoted desktop.

The disclosure encompasses systems, methods and computer-readable storage media for implementing these teachings.

It can be appreciated by one of skill in the art that one or more various aspects of the disclosure may include but are not limited to circuitry and/or programming for effecting the herein-referenced aspects of the present disclosure; the circuitry and/or programming can be virtually any combination of hardware, software, and/or firmware configured to effect the herein-referenced aspects depending upon the design choices of the system designer.

The foregoing is a summary and thus contains, by necessity, simplifications, generalizations and omissions of detail. Those skilled in the art will appreciate that the summary is illustrative only and is not intended to be in any way limiting.

### BRIEF DESCRIPTION OF THE DRAWINGS

The systems, methods, and computer-readable media for efficient navigation of and interaction with a remoted desktop that is larger than the local viewing area are further described with reference to the accompanying drawings in which:

FIG. 1 illustrates an exemplary general purpose computing environment in which in which the techniques described herein may be embodied.

FIG. 2 depicts an example terminal server wherein aspects of the present disclosure can be implemented.

FIG. 3 illustrates an example of a portion of a natively displayed remoted desktop in conjunction with the remoted desktop, and navigation techniques.

FIG. 4 illustrates an example process flow for improved navigation of and interaction with a remoted desktop that is larger than the client display area using a mini-map.

FIG. 5 illustrates an example process flow for improved navigation of and interaction with a remoted desktop that is larger than the client display area using a mouse.

FIG. 6 illustrates an example process flow for improved navigation of and interaction with a remoted desktop that is larger than the client display area using a mouse scroll wheel.

FIG. 7 illustrates example operational procedures for efficient navigation of and interaction with a remoted desktop that is larger than the local viewing area.

### DETAILED DESCRIPTION OF ILLUSTRATIVE EMBODIMENTS

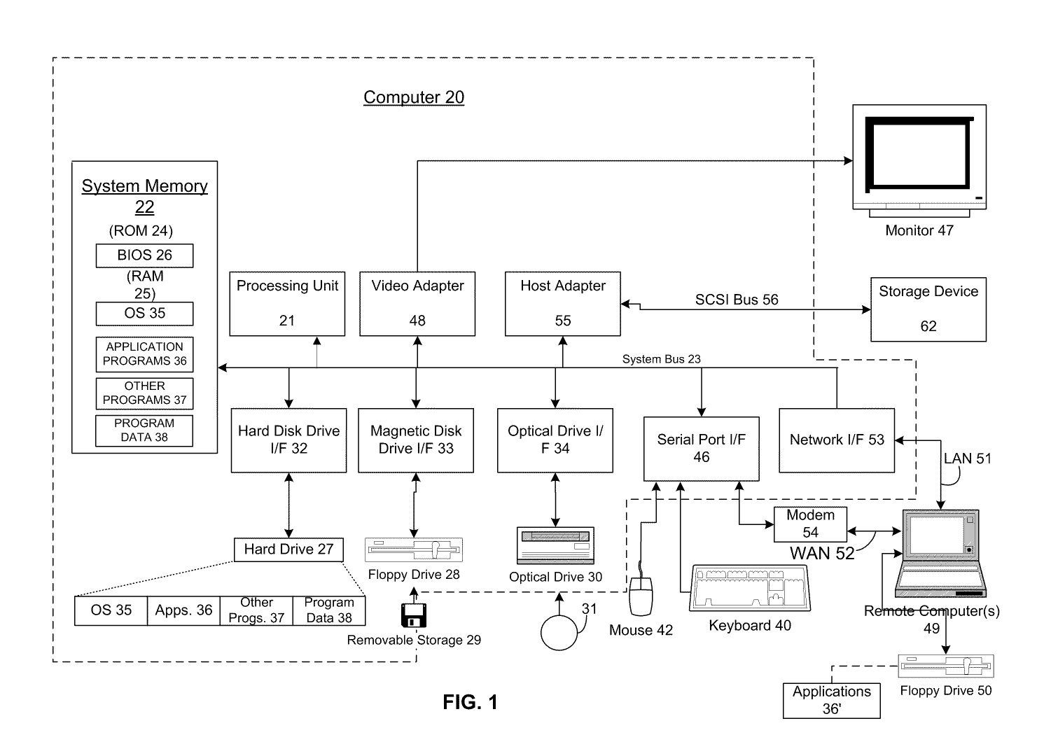

FIG. 1 is a block diagram of a general purpose computing device in which the techniques described herein may be employed. The computing system environment 20 is only one example of a suitable computing environment and is not intended to suggest any limitation as to the scope of use or functionality of the presently disclosed subject matter. Neither should the computing environment 20 be interpreted as having any dependency or requirement relating to any one or combination of components illustrated in the exemplary operating environment 20. In some embodiments the various depicted computing elements may include circuitry configured to instantiate specific aspects of the present disclosure. For example, the term circuitry used in the disclosure can include specialized hardware components configured to perform function(s) by firmware or switches. In other examples embodiments the term circuitry can include a general purpose processing unit, memory, etc., configured by software instructions that embody logic operable to perform function(s). In example embodiments where circuitry includes a combination of hardware and software, an implementer may write source code embodying logic and the source code can be compiled into machine readable code that can be processed by the general purpose processing unit. Since one skilled in the art can appreciate that the state of the art has evolved to a point where there is little difference between hardware, software, or a combination of hardware/software, the selection of hardware versus software to effectuate specific functions is a design choice left to an implementer. More specifically, one of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer.

Computer 20 typically includes a variety of computer-readable media. Computer-readable media can be any available media that can be accessed by computer 20 and includes both volatile and nonvolatile media, removable and non-removable media. The system memory 22 includes computer-readable storage media in the form of volatile and/or nonvolatile memory such as read only memory (ROM) 24 and random access memory (RAM) 25. A basic input/output system 26 (BIOS), containing the basic routines that help to transfer information between elements within computer 20, such as during start-up, is typically stored in ROM 24. RAM 25 typically contains data and/or program modules that are immediately accessible to and/or presently being operated on by processing unit 21. By way of example, and not limitation, FIG. 1 illustrates operating system 35, application programs 36, other program modules 37, and program data 38.

The computer 20 may also include other removable/non-removable, volatile/nonvolatile computer storage media. By way of example only, FIG. 1 illustrates a hard disk drive 27 that reads from or writes to non-removable, nonvolatile magnetic media, a magnetic disk drive 28 that reads from or writes to a removable, nonvolatile magnetic disk 29, and an optical disk drive 30 that reads from or writes to a removable, nonvolatile optical disk 31 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 27 is typically connected to the system bus 23 through an non-removable memory interface such as interface 32, and magnetic disk drive 28 and optical disk drive 30 are typically connected to the system bus 23 by a removable memory interface, such as interface 33.

The drives and their associated computer storage media discussed above and illustrated in FIG. 1, provide storage of computer-readable instructions, data structures, program modules and other data for the computer 41. In FIG. 1, for example, hard disk drive 27 is illustrated as storing operating system 35, application programs 36, other program modules 37, and program data 38. Note that these components can either be the same as or different from operating system 35, application programs 36, other program modules 37, and program data 38 stored in system memory 22. A user may enter commands and information into the computer 20 through input devices such as a keyboard 40 and pointing device 42, commonly referred to as a mouse, trackball or touch pad. Other input devices (not shown) may include a microphone, joystick, game pad, satellite dish, scanner, or the like. These and other input devices are often connected to the processing unit 21 through a user input interface 46 that is coupled to the system bus, but may be connected by other interface and bus structures, such as a parallel port, game port or a universal serial bus (USB). A monitor 47 or other type of display device is also connected to the system bus 23 via an interface, such as a video interface 48. In addition to the monitor, computers may also include other peripheral output devices such as speakers and printer, which may be connected through a output peripheral interface.

The computer 20 may operate in a networked environment using logical connections to one or more remote computers, such as a remote computer 49. The remote computer 49 may be a personal computer, a server, a router, a network PC, a peer device or other common network node, and typically includes many or all of the elements described above relative to the computer 20, although only a memory storage device 50 has been illustrated in FIG. 1. The logical connections depicted in FIG. 1 include a local area network (LAN) 51 and a wide area network (WAN) 52, but may also include other networks. Such networking environments are commonplace in offices, enterprise-wide computer networks, intranets and the Internet.

When used in a LAN networking environment, the computer 20 is connected to the LAN 51 through a network interface or adapter 53. When used in a WAN networking environment, the computer 20 typically includes a modem 50 or other means for establishing communications over the WAN 49, such as the Internet. The modem 54, which may be internal or external, may be connected to the system bus 23 via the user input interface 46, or other appropriate mechanism. In a networked environment, program modules depicted relative to the computer 20, or portions thereof, may be stored in the remote memory storage device. By way of example, and not limitation, FIG. 1 illustrates remote application programs 36′ as residing on memory device 50. It will be appreciated that the network connections shown are exemplary and other means of establishing a communications link between the computers may be used.

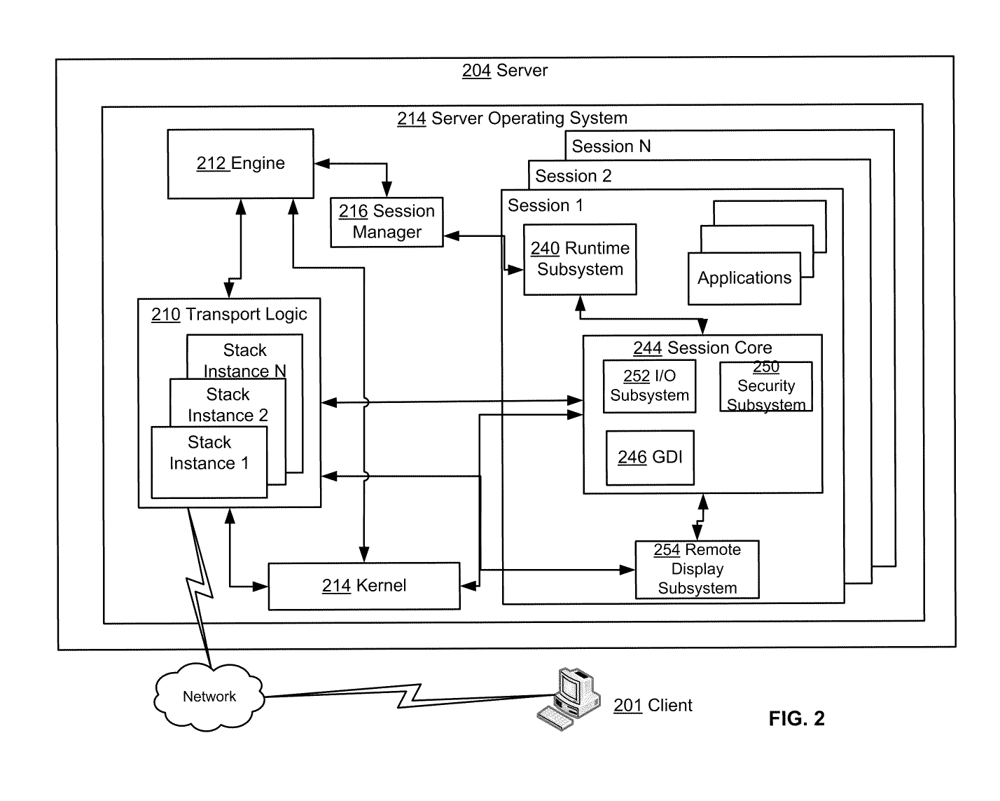

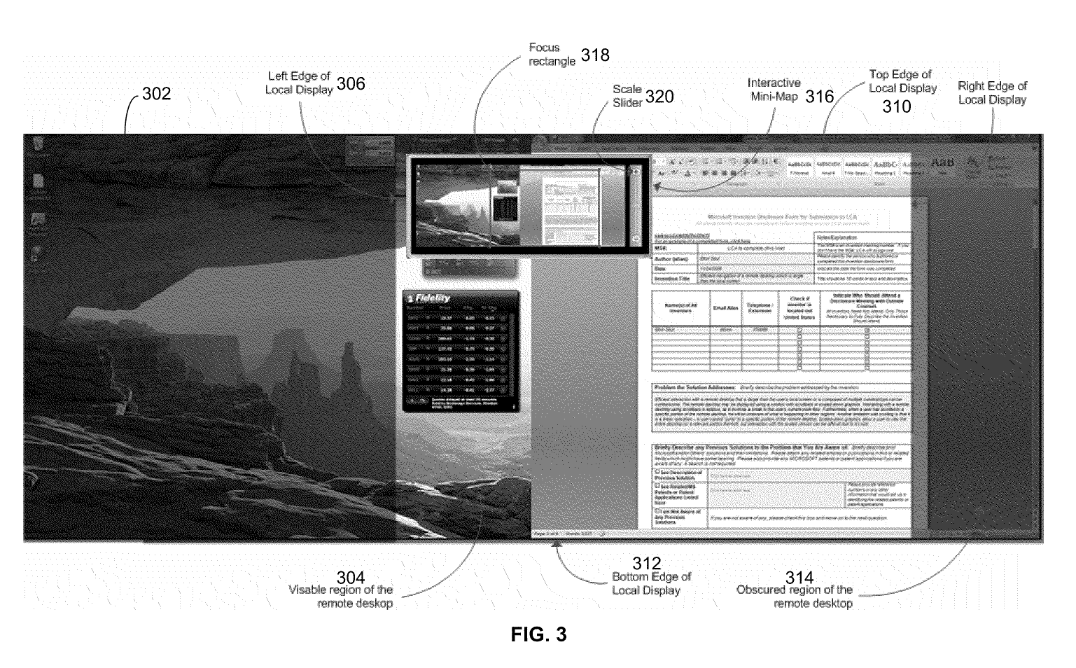

Referring now to FIG. 2, it generally illustrates an example environment wherein aspects of the present disclosure can be implemented. One skilled in the art can appreciate that the example elements depicted by FIG. 2 are illustrated to provide an operational framework for describing the present disclosure. Accordingly, in some embodiments the physical layout of each environment may be different depending on different implementation schemes. Thus the example operational framework is to be treated as illustrative only and in no way limit the scope of the claims. One skilled in the art can also appreciate that the following discussion is introductory and the elements depicted by FIG. 2 are described in more detail within the discussion of the techniques depicted by FIG. 3 through FIG. 7.

Generally, FIG. 2 depicts a high level overview of a server environment that can be configured to include aspects of the present disclosure. In reference to the figure, depicted is a server 204 that can include circuitry configured to effectuate a remote presentation session server, such as a terminal server, or in other embodiments the server 204 can include circuitry configured to support remote presentation session connections. In the depicted example, the server 204 can be configured to generate one or more sessions for connecting clients such as sessions 1 through N (where N is an integer greater than 2). Briefly, a session in example embodiments of the present disclosure can generally include an operational environment that is effectuated by a plurality of subsystems, e.g., software code, that are configured to interact with a kernel 214 of server 204. For example, a session can include a process that instantiates a user interface such as a desktop window, the subsystems that track mouse movement within the window, the subsystems that translate a mouse click on an icon into commands that effectuate an instance of a program, etc. A session can be generated by the server 204 on a user by user basis by the server 204 when, for example, the server 204 receives a connection request over a network connection from a client 201. Generally, a connection request can first be handled by the transport logic 210 that can, for example, be effectuated by circuitry of the server 204. The transport logic 210 can in some embodiments include a network adaptor; firmware, and software that can be configured to receive connection messages and forward them to the engine 212. As illustrated by FIG. 2, the transport logic 210 can in some embodiments include protocol stack instances for each session. Generally, each protocol stack instance can be configured to route user interface output to a client and route user input received from the client to the session core 244 associated with its session.

Continuing with the general description of FIG. 2, the engine 212 in some example embodiments of the present disclosure can be configured to process requests for sessions; determine the functionality for each session; generate sessions by allocating a set of physical resources for the session; and instantiating a protocol stack instance for the session. In some embodiments the engine 212 can be effectuated by specialized circuitry components that can implement some of the above mentioned operational procedures. For example, the circuitry in some example embodiments can include memory and a processor that is configured to execute code that effectuates the engine 212. As depicted by FIG. 2, in some instances the engine 212 can receive connection requests and determine that, for example, a license is available and a session can be generated for the request. In the situation where the server 204 is a remote computer that includes remote presentation session capabilities, the engine 212 can be configured to generate a session in response to a connection request without checking for a license. As illustrated by FIG. 2, a session manager 216 can be configured to receive a message from an engine 212 and in response to the message the session manager 216 can add a session identifier to a table; assign memory to the session identifier; and generate system environment variables and instances of subsystem processes in memory assigned to the session identifier.

As illustrated by FIG. 2, the session manager 216 can instantiate environment subsystems such as a runtime subsystem 240 that can include a kernel mode part such as the session core 244. For example, the environment subsystems in an embodiment are configured to expose some subset of services to application programs and provide an access point to the kernel of the operating system 214. In example embodiments the runtime subsystem 240 can control the execution of processes and threads and the session core 244 can send requests to the executive of the kernel 214 to allocate memory for the threads and schedule time for them to be executed. In an embodiment the session core 244 can include a graphics display interface 246 (GDI), a security subsystem 250, and an input subsystem 252. The input subsystem 252 can in these embodiments be configured to receive user input from a client 201 via the protocol stack instance associated with the session and transmit the input to the session core 244 for the appropriate session. The user input can in some embodiments include signals indicative of absolute and/or relative mouse movement commands, mouse coordinates, mouse clicks, keyboard signals, joystick movement signals, etc. User input, for example, a mouse double-click on an icon, can be received by the session core 244 and the input subsystem 252 can be configured to determine that an icon is located at the coordinates associated with the double-click. The input subsystem 252 can then be configured to send a notification to the runtime subsystem 240 that can execute a process for the application associated with the icon.

In addition to receiving input from a client 201, drawing commands can be received from applications and/or a desktop and be processed by the GDI 246. The GDI 246 in general can include a process that can generate graphical object drawing commands. The GDI 246 in this example embodiment can be configured to pass its output to the remote display subsystem 254 where the commands are formatted for the display driver that is attached to the session. In certain example embodiments one or more physical displays can be attached to the server 204, e.g., in a remote presentation session situation. In these example embodiments the remote display subsystem 254 can be configured to mirror the draw commands that are rendered by the display driver(s) of the remote computer system and transmit the mirrored information to the client 201 via a stack instance associated with the session. In another example embodiment, where the server 204 is a terminal server, the remote display subsystem 254 can be configured to include virtual display driver(s) that may not be associated with displays physically attacked to the server 204, e.g., the server 204 could be running headless. The remote display subsystem 254 in this embodiment can be configured to receive drawing commands for one or more virtual displays and transmit them to the client 201 via a stack instance associated with the session. In an embodiment of the present disclosure, the remote display subsystem 254 can be configured to determine the display resolution for each display driver, e.g., determine the display resolution of the virtual display driver(s) associated with virtual displays or the display resolution of the display drivers associated with physical displays; and route the packets to the client 201 via the associated protocol stack instance.

In some example embodiments the session manager 216 can additionally instantiate an instance of a logon process associated with the session identifier of the session that can be configured to handle logon and logoff for the session. In these example embodiments drawing commands indicative of the graphical user interface associated with the logon process can be transmitted to the client 201 where a user of the client 201 can input an account identifier, e.g., a username/password combination, a smart card identifier, and/or biometric information into a logon screen. The information can be transmitted to server 204 and routed to the engine 212 and the security subsystem 250 of the session core 244. For example, in certain example embodiments the engine 212 can be configured to determine whether the user account is associated with a license; and the security subsystem 250 can be configured to generate a security token for the session.

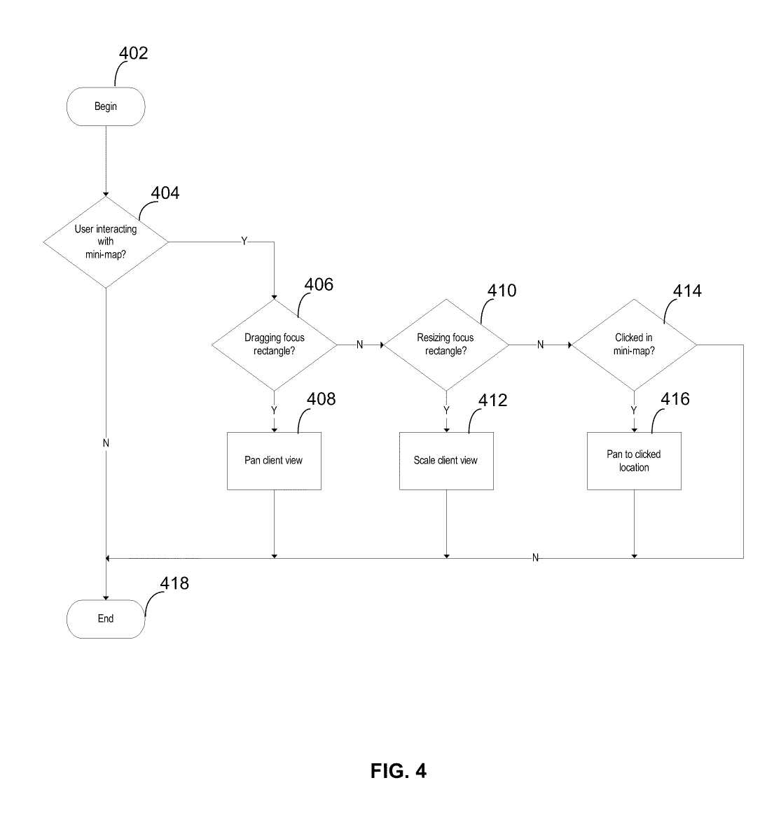

FIG. 3 illustrates an example of a portion of a natively displayed remoted desktop in conjunction with the remoted desktop, and navigation techniques. The elements of FIG. 3 are incorporated into the present techniques in FIGS. 4-6, below. The term “natively displayed” is used herein, most often in the context of “the portion of the remoted desktop that is natively displayed.” It may be appreciated that the portion of the remoted desktop that is natively displayed may not always be displayed in the remote presentation server's native resolution, such as if a zoom operation is performed on it. The term may be thought of as referring to that larger portion of the remoted desktop displayed to the user, as opposed to the mini-map.

Remoted desktop 302 is a desktop that is sent from a server to a client in a remote presentation session for local display by the client. Where the client cannot display the full remoted desktop at once (such as if the display device upon which the client displays it is too small to display it in its native resolution, or a window in which the client displays it is too small to display it in its native resolution), the client displays only a portion of the remoted desktop 304. This displayed portion 304 may be thought of as having a left edge 306, a right edge 308, a top edge 310, and a bottom edge 312. Since the displayed portion 304 comprises only a portion of the remoted desktop, there is an obscured region of the remoted desktop 314—one which is not displayed within the portion.

Remoted desktop 302 may comprise a desktop as displayed across a plurality of display devices on a remote presentation session server. For instance, the client may not be able to display the full remoted desktop at once in its native resolution because the remoted desktop spans three 1600×1200 pixel monitors, while the client has only one 1600×1200 pixel monitor as a display device. In an embodiment, a remote presentation session server takes a remoted desktop spanning multiple monitors, and from it, creates a single, joined image that comprises the entire remoted desktop. Where a separate display driver is used by the server to generate the graphical output for each monitor, this may comprise receiving the graphical output from each of these display drivers and cojoining the received graphical output. When the server then sends remoted desktop 302 to a client, it may also send an indication of which parts of the remoted desktop 302 correspond to each monitor on the server. Techniques for doing this are discussed in more detail, below.

Having received an indication of which parts of a remoted desktop 302 correspond to which of a plurality of monitors of the server, the client may then indicate this on its display device. For instance, a line may be used to demarcate each monitor in a mini-map 316, or shortcuts may be provided to navigate between the parts of the remoted desktop corresponding to particular monitors. In some use situations, it may be valuable to efficiently navigate between the parts of the remoted desktop corresponding to particular monitors because an application window is entirely contained within a monitor, because it may be difficult for a user to interact with a window that is partially on one monitor and partially on another. So, by navigating to a particular monitor, the client may display in the portion of the remoted desktop 304 an image that does not partially show any windows.

Techniques to navigate between the parts of the remoted desktop corresponding to particular monitors may include a hot key on an input device (such as a keyboard) assigned to each such monitor, or a way to present input to a mini-map (such as through a mouse click, or mouse click in conjunction with a key press on an input device) indicative of displaying the indicated part of the remoted desktop corresponding to a particular monitor on the server.

Mini-map 316 is a scaled-down representation of the entire remoted desktop—the entire remoted desktop is displayed, but in a much smaller manner than its native resolution. A client that receives a complete remoted desktop image across a remote presentation session may generate a mini-map from that image. Upon mini-map 316 is displayed a focus rectangle 318—an indication of the portion of the natively displayed remoted desktop that is being displayed at the current time. For instance, if the upper left portion of the remoted desktop is being displayed in its native resolution within local display 306, then focus rectangle 318 is located in the upper left corner of mini-map 318.

Mini-map 316 may also display scale slider 320. Through manipulating scale slider 320, the natively displayed portion of the remoted desktop may be zoomed into or out from. In this case where the portion is zoomed in or out via scale slider 320, it is a misnomer to call it “natively displayed,” since by virtue of zooming in or out, the portion is no longer displayed at its native resolution.

FIGS. 4-6 illustrate process flows for improved navigation of and interaction with a remoted desktop that is larger than the client display. The process flows may be executed in tandem—they are not mutually exclusive—and may be implemented as loops, such that a system implementing these process flows is continually checking for additional user input indicative of improved navigation of and interaction with a remoted desktop that is larger than the client display.

FIG. 4 illustrates an example process flow for improved navigation of and interaction with a remoted desktop that is larger than the client display area using a mini-map.

The process flow begins at operation 402. If, at operation 404, the user is interacting with a mini-map, such as by clicking on it with a mouse-pointer, or using a mouse pointer to drag a moveable portion of it (like a rectangle that indicates the current natively displayed portion of the remoted desktop), the process flow moves to operation 406. If the user is not interacting with the mini-map, the process flow ends at operation 418. In an embodiment, the process flow loops back to operation 402 to further detect user interaction with the mini-map.

If, at operation 406, it is determined that the user is dragging a focus rectangle (or other shape) of the mini-map, the process flow moves to operation 408. The user may drag the focus rectangle, for instance, where he uses a mouse pointer to click inside the focus rectangle's border, and holds that click while moving the mouse pointer. At operation 408, the view of the natively displayed portion of the remoted desktop is moved to reflect the new location of this focus rectangle. For instance, if the focus rectangle begins in the upper left corner of the mini-map (thus, the natively displayed portion of the remoted desktop is displaying the upper left corner of the remoted desktop) and then is moved by user input to the upper right corner of the mini-map, then the natively displayed portion is switched to the upper right corner of the remoted desktop to correspond to the location of the focus rectangle in the mini-map. When operation 408 completes, the process flow moves to operation 418. In another embodiment, the process flow may then move to operation 410 or operation 414 to check for the existence of additional user input.

If, at operation 406, it is determined that the user is not dragging a focus rectangle of the mini-map, the process flow moves to operation 410. If, at operation 410, it is determined that the user is resizing the focus rectangle, the process flow moves to operation 412. The user may resize the focus rectangle, for instance, where he uses a mouse pointer to click on the focus rectangle's border, and holds that click while moving the mouse pointer, which results in the size of the focus rectangle changing. At operation 412, the portion of the natively displayed remoted desktop is zoomed in or out. This zooming may be done proportional to the amount of resizing determined in operation 410. For instance, if the user drags the focus rectangle's perimeter to quadruple the area of the focus rectangle (double the width and double the height), this may result in the portion of the natively displayed remoted desktop to be doubled in each dimension as well. Since the space in which the portion is presented holds constant, this would result in zooming out on the portion so that it all fits within this constant space. As discussed above with respect to scale slider 320, in this case where the portion is zoomed in or out, it is a misnomer to call it “natively displayed,” since by virtue of zooming in or out, the portion is no longer displayed at its native resolution. When operation 412 completes, the process flow moves to operation 418. In another embodiment, the process flow may then move to operation 406 or operation 414 to check for the existence of additional user input.

If, at operation 410, it is determined that the user is not resizing the focus rectangle, the process flow moves to operation 414. If, at operation 414, it is determined that the user has clicked inside the mini-map, the process flow moves to operation 416. The user may click inside the mini-map, for instance, where he positions a mouse pointer within the boundaries of the mini-map, then depresses and then quickly releases that mouse's click button. At operation 416, the portion of the natively displayed desktop is panned to this clicked location. In an embodiment, this comprises centering the portion of the natively displayed desktop on a position corresponding to the position clicked by the user in the mini-map. In an embodiment, the portion cannot be centered on a position corresponding to the position clicked by the user in the mini-map, such as when the user clicks close to the edge of the mini-map. In an embodiment where this occurs, the portion may be panned as nearly as possible to be centered, without going outside of the border of the remoted desktop. When operation 416 completes, the process flow moves to operation 418. In another embodiment, the process flow may then move to operation 406 or operation 410 to check for the existence of additional user input.

If, at operation 414, it is determined that the user has not clicked inside the mini-map, the process flow moves to operation 418.

It may be appreciated that, as with other aspects of the present techniques, the order of operations 406, 410, and 414 may be switched. Also as with other aspects of the present techniques, not all of operations 406, 410, and 414 may be implemented in a particular embodiment.

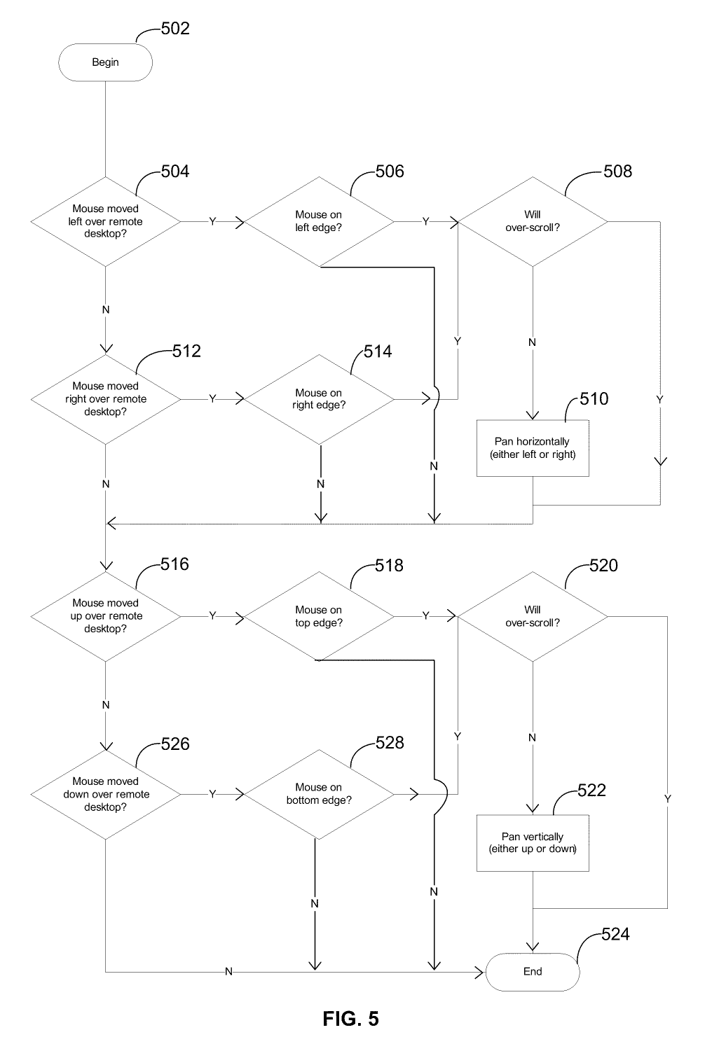

FIG. 5 illustrates an example process flow for improved navigation of and interaction with a remoted desktop that is larger than the client display area using a mouse.

The process flow begins with operation 502, which leads to operation 504. At operation 504, it is determined whether the mouse has been moved to the left over the natively displayed portion of the remoted desktop. If it is determined that the mouse has been moved to the left over the natively displayed portion of the remoted desktop, the process flow moves to operation 506.

At operation 506, it is determined whether the mouse is at the left edge of the displayed portion of the remoted desktop. If the mouse is at the left edge of the displayed portion of the remoted desktop, the process flow moves to operation 508.

At operation 508, it is determined whether over-scroll is enabled for this remote presentation session. Over-scroll comprises moving the natively displayed portion of the remoted desktop when a mouse pointer reaches an edge of the display device upon which the natively displayed portion of the remoted desktop is presented. For instance, if the mouse pointer reaches the left edge of the display device, where over-scroll is enabled, the natively displayed portion of the remoted desktop will be panned to the right some distance so that the mouse pointer is now no longer at the left edge of the natively displayed portion of the remoted desktop. This allows a user to navigate through a remoted desktop solely by moving his or her mouse in the direction he wishes to navigate.

This determination of operation 508 may be done, for example, by checking a remote presentation session preferences file for the client, in which a flag may be set that states whether over-scroll is enabled. If it is determined that over-scroll is enabled for this remote presentation session, the process flow moves to operation 510.

At operation 510, where this operation has been reached from operation 506, as above, the natively displayed portion of the remoted desktop is panned to the right, as described above.

Returning to operation 504, where it is determined that the mouse pointer has not been moved left over the natively displayed portion of the remoted desktop, the process flow moves to operation 512.

At operation 512, it is determined whether the mouse pointer has been moved right over the natively displayed portion of the remoted desktop. If the mouse pointer has been moved right over the natively displayed portion of the remoted desktop, the process flow moves to operation 514.

At operation 514, it is determined whether the mouse is at the right edge of the display device. If the mouse is at the right edge of the display device, the process flow moves to operation 508, as described above, and then to operation 510. Operation 510 performs as described above, save for that the natively displayed portion of the remoted desktop is panned to the left, as opposed to the right.

Returning to operation 512, where it is determined that the mouse pointer has not been moved right over the natively displayed portion of the remoted desktop, the process flow moves to operation 516.

At operation 516, it is determined whether the mouse pointer has been moved up over the natively displayed portion of the remoted desktop. If the mouse pointer has been moved up over the natively displayed portion of the remoted desktop, the process flow moves to operation 518.

At operation 518, it is determined whether the mouse is at the top edge of the display device. If the mouse is at the top edge of the display device, the process flow moves to operation 520.

At operation 520, it is determined whether over-scroll is enabled for this remote presentation session. As with operation 508, this determination of operation 520 may be done, for example, by checking a remote presentation session preferences file for the client, in which a flag may be set that states whether over-scroll is enabled. If it is determined that over-scroll is enabled for this remote presentation session, the process flow moves to operation 522.

At operation 522, where this operation has been reached from operation 518, as above, the natively displayed portion of the remoted desktop is panned downward, as described above. The process flow then moves to operation 524 where it concludes.

Returning to operation 516, where it is determined that the mouse pointer has not been moved up over the natively displayed portion of the remoted desktop, the process flow moves to operation 526.

At operation 526, it is determined whether the mouse pointer has been moved down over the natively displayed portion of the remoted desktop. If the mouse pointer has been moved down over the natively displayed portion of the remoted desktop, the process flow moves to operation 528.

At operation 528, it is determined whether the mouse is at the bottom edge of the displayed portion of the remoted desktop. If the mouse is at the bottom edge of the display device, the process flow moves to operations 520 and 522. Operations 520 and 522 perform as described above, save for that the natively displayed portion of the remoted desktop is panned upward, as opposed to downward.

The process flow then moves to operation 524 where it concludes. In an embodiment, upon reaching operation 524, the process flow may loop to check for more mouse input indicative of over-scroll, by returning to operation 502.

It may be appreciated that alternative embodiments to this process flow exist. For instance, the order of operations 504, 512, 516, and 516 may be changed. Where an operation comprises making a determination, and a result of that determination is not described (for instance, where the result of operation 506 is a determination that the mouse is not on the left edge), in an embodiment, the process flow moves to operation 524. For the sake of cleanliness, some of these branches of logic have not been depicted in the process flow, though they may be appreciated by one skilled in the art.

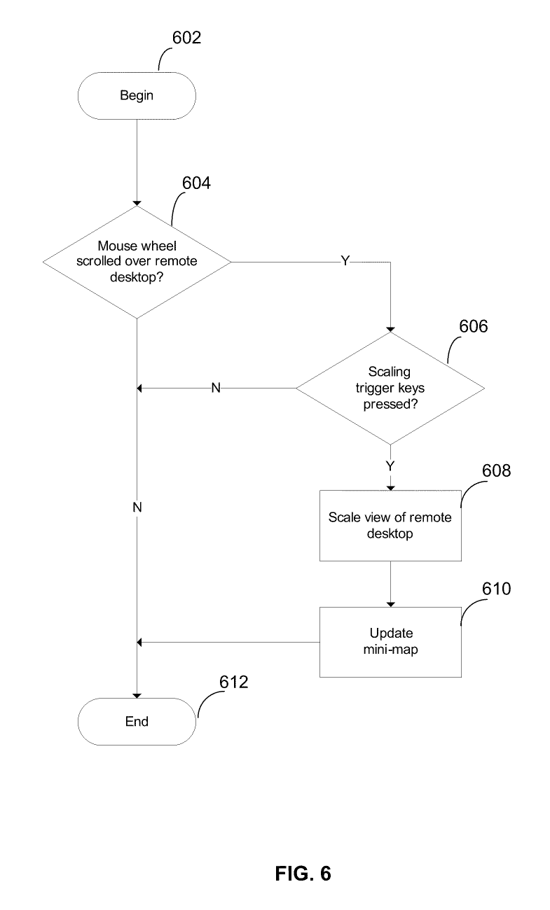

FIG. 6 illustrates an example process flow for improved navigation of and interaction with a remoted desktop that is larger than the client display area using a mouse scroll wheel. While the embodiment discussed herein comprises a mouse scroll wheel, it may be appreciated that other means of input may be used to indicate similar navigation.

The process flow begins at operation 602, which leads to operation 604. At operation 604, it is determined whether the mouse scroll wheel was scrolled while the mouse pointer was located over the natively displayed portion of the remoted desktop. The wheel may be scrolled in multiple ways to convey information. For instance, most scroll wheels may be scrolled in two directions, and it may be that scrolling the wheel in a first direction corresponds to zooming in, and scrolling the wheel in a second direction corresponds to zooming out. If the mouse scroll wheel was scrolled while the mouse pointer was located over the natively displayed portion of the remoted desktop, the process flow moves to operation 606.

At operation 606, it is determined whether a scaling trigger key was pressed while the mouse scroll wheel was scrolled while the mouse pointer was located over the natively displayed portion of the remoted desktop. A scaling trigger key may be a button of the mouse, or a designated key on an associated keyboard, such as the “control” key. In an embodiment, no scaling trigger key is used, and sole use of the mouse scroll wheel in operation 604 determines scaling. If a scaling trigger key was pressed while the mouse scroll wheel was scrolled while the mouse pointer was located over the natively displayed portion of the remoted desktop, the process flow moves to operation 608.

At operation 608, the natively displayed portion of the remoted desktop is scaled. This may comprise scaling it in proportion to the amount of mouse wheel scrolling detected in operation 604. For instance, if the mouse wheel was scrolled a small amount, the natively displayed portion of the remoted desktop may be scaled a small amount, and if the mouse wheel is scrolled a large amount, the natively displayed portion of the remoted desktop may be scaled a large amount. The process flow then moves to operation 610.

At operation 610, the mini-map is updated to reflect the scaling of operation 608. For instance, where the mini-map displays focus rectangle 318, where the natively displayed portion of the remoted desktop is zoomed in to display less of the remoted desktop, the focus rectangle is decreased in size to reflect that the natively displayed portion of the remoted desktop displays less of the remoted desktop.

The process flow then moves to operation 612 where the process flow concludes. In an embodiment, the process flow then returns to operation 602 to detect additional navigation using the mouse scroll wheel.

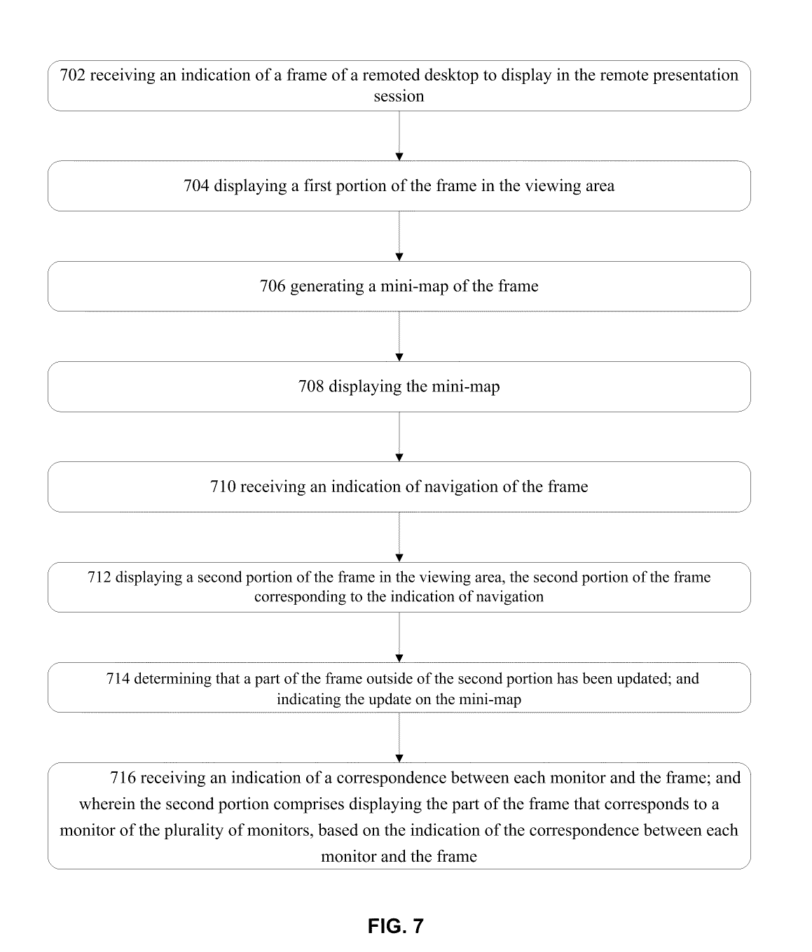

FIG. 7 depicts displaying a remoted desktop sent across a remote presentation system in a viewing area with a dimension smaller than a corresponding dimension of the remoted desktop. For instance, the width of the viewing area may be smaller than the width of the remoted desktop, such as where the width of the viewing area is 800 pixels, and the width of the remoted desktop is 1600 pixels.

Operation 702 depicts receiving an indication of a frame of a remoted desktop to display in the remote presentation session. As the remote presentation session generates frames of the remoted desktop, it indicates to the client to display those frames. This may comprise sending the client the entire frame. In an embodiment where a frame is subdivided into tiles, and those tiles are cached by the client, this may comprise sending the client those tiles that the client has not been sent previously, as well as an indication of those tiles that the client has cached, as well as an indication of how those tiles are to be arranged to form the frame.

Operation 704 depicts displaying a first portion of the frame in the viewing area. Where this is the initial frame sent in a remote presentation session, this portion to display may be a default portion, such as the upper left corner of the frame. Where this operation occurs within the context of an ongoing remote presentation session, this portion may be the same portion as the most recently displayed frame, assuming that no navigation (such as described in operations 710 and 712) has occurred in the interim. For instance, the portion of the most recently displayed frame may have been a portion the size of the viewing area with an upper left corner located 50 pixels to the right and 50 pixels below the upper left corner of the frame. Then this new first portion may also be a portion the size of the viewing area with an upper left corner located 50 pixels to the right and 50 pixels below the upper left corner of the frame.

Operation 706 depicts generating a mini-map of the frame. In an embodiment where the client receives the full frame, rather than the portion to be displayed in the viewing area, this may comprise generating a mini-map from the frame, such as by scaling down the frame to the size of the area of the mini-map.

Operation 708 depicts displaying the mini-map.

Operation 710 depicts receiving an indication of navigation of the frame.

In an embodiment, the indication of navigation comprises over-scroll of an on-screen pointer. As discussed with respect to FIG. 5, this may comprise moving the natively displayed portion of the remoted desktop when a mouse pointer reaches an edge of the natively displayed portion of the remoted desktop.

In an embodiment, the indication of navigation comprises a wheel scroll, and the second portion comprises the first portion zoomed in or zoomed out. This wheel scroll may be from a physical object, such as a scroll wheel on a computer mouse or other computer input device. In an embodiment, the indication of navigation further comprises a button press simultaneous with the wheel scroll. For instance, a keyboard button may be depressed concurrently with the wheel scroll to cause the indication of navigation.

In an embodiment wherein the mini-map comprises a focus rectangle, the indication of navigation may comprise a manipulation of the focus rectangle. In an embodiment, the manipulation of the focus rectangle comprises dragging the focus rectangle, such as with a mouse pointer. In an embodiment, the manipulation of the focus rectangle comprises resizing the focus rectangle, again, such as through use of a mouse pointer.

In an embodiment, the indication of manipulation comprises a mouse click in the mini-map. This may be done, for instance, to center the focus rectangle around the location of the mouse pointer when the mouse click occurred.

In an embodiment, the indication of manipulation comprises a multi-touch gesture. This may comprise input made to a touch-sensitive input device, such as a track pad or a touch-screen display. For instance, an indication to move the focus rectangle may comprise tapping on a touch-sensitive input device when an associated pointer is positioned over the mini-map.

Operation 712 depicts displaying a second portion of the frame in the viewing area, the second portion of the frame corresponding to the indication of navigation. Upon receiving an indication of navigation as in operation 710, the corresponding navigation may be performed on the frame, and the resulting portion of the frame (herein referred to as the second portion) may be displayed in the viewing area.

Operation 714 depicts determining that a part of the frame outside of the second portion has been updated; and indicating the update on the mini-map. Where only a portion of the frame is shown in the viewing area, it may be difficult for one to notice that part of the frame has been updated (such as a dialog box for an application has appeared) without navigating through the entire frame. To aid in such noticing, that update may be indicated on the mini-map, such as by making a light flashing effect in either the area that contains the update, or the mini-map as a whole.

Operation 716 depicts, wherein the remoted desktop spans a plurality of monitors, receiving an indication of a correspondence between each monitor and the frame; and wherein the second portion comprises displaying the part of the frame that corresponds to a monitor of the plurality of monitors, based on the indication of the correspondence between each monitor and the frame. The remoted display may have a dimension larger than the viewing area because it comprises the display of two monitors while the viewing area comprises only one monitor. Additionally, monitors may be relatively self-contained working areas—an application window is contained entirely within one monitor rather than partially in one monitor and partially in another monitor. In light of this, it may improve navigation to enable a user to rapidly navigate between displaying monitors.

In an embodiment, this is accomplished by the server sending the client the coordinates of each monitor within the frame (e.g. in Cartesian coordinates monitor one has an upper left corner of (0 pixels, 0 pixels) and a lower right corner of (800, −600), while monitor two has an upper left corner of (800, 0) and a lower right corner of (1600, −600)). Then, when the indication of navigation comprises displaying the second monitor, the client may display in the upper left corner of the viewing area that portion of the frame that begins at (800, 0).

### CONCLUSION

While the present disclosure has been described in connection with the preferred aspects, as illustrated in the various figures, it is understood that other similar aspects may be used or modifications and additions may be made to the described aspects for performing the same function of the present disclosure without deviating therefrom. Therefore, the present disclosure should not be limited to any single aspect, but rather construed in breadth and scope in accordance with the appended claims. For example, the various procedures described herein may be implemented with hardware or software, or a combination of both. Thus, the methods and apparatus of the disclosed embodiments, or certain aspects or portions thereof, may take the form of program code (i.e., instructions) embodied in tangible media, such as floppy diskettes, CD-ROMs, hard drives, or any other machine-readable storage medium. When the program code is loaded into and executed by a machine, such as a computer, the machine becomes an apparatus configured for practicing the disclosed embodiments. In addition to the specific implementations explicitly set forth herein, other aspects and implementations will be apparent to those skilled in the art from consideration of the specification disclosed herein. It is intended that the specification and illustrated implementations be considered as examples only.

What is claimed:

1. A system for displaying a remoted desktop sent from a server across a remote presentation system in a viewing area with a dimension smaller than a corresponding dimension of the remoted desktop, comprising:
a processor; and
a memory communicatively coupled to the processor, bearing computer-readable instructions that when executed on the processor, cause the processor to perform operations comprising:
receiving an indication of a frame of a remoted desktop to display in the remote presentation session, the remoted desktop corresponding to a plurality of display devices of the server;
receiving an indication of a correspondence between each of the plurality of display devices and the frame;
displaying a first portion of the frame in the viewing area;
receiving an indication to navigate to a selected display device of the plurality of display devices;
determining a second portion of the frame corresponding to the selected display device; and
displaying the second portion of the frame in the viewing area.

2. The system of claim 1, wherein the memory further bears computer-readable instructions that when executed on the processor, cause the processor to perform operations comprising:
generating a mini-map of the frame;
displaying the mini-map; and wherein the indication to navigate comprises:
an indication to navigate received at the mini-map.

3. The system of claim 1, wherein the mini-map comprises:
a visual indication of the correspondence between each of the plurality of display devices and the frame.

4. A method for displaying a remoted desktop sent by a server across a remote presentation session in a viewing area with a dimension smaller than a corresponding dimension of the remoted desktop, comprising:
receiving an indication of a frame of a remoted desktop to display in the remote presentation session;
displaying a first portion of the frame in the viewing area;
generating a mini-map of the frame;
displaying the mini-map;
receiving an indication of navigation of the frame; and
displaying a second portion of the frame in the viewing area, the second portion of the frame corresponding to the indication of navigation.

5. The method of claim 1, wherein the remoted desktop corresponds to a plurality of display devices of the server, further comprising:
receiving an indication of a correspondence between each of the plurality of display devices and the frame;
wherein receiving an indication of navigation of the frame comprises:
receiving an indication of a display device of the plurality of display devices; and
wherein the second portion of the frame comprises:
a portion of the frame corresponding to the display device.

6. The method of claim 1, wherein the remoted desktop corresponds to a plurality of display devices of the server, further comprising:
receiving an indication of a correspondence between each of the plurality of display devices and the frame;
wherein displaying the mini-map comprises:
displaying an indication of the correspondence between each of the plurality of display devices and the frame in the mini-map.

7. The method of claim 3, wherein receiving an indication of navigation of the frame further comprises:
receiving indication at the mini-map of a selected display device of the plurality of display devices; and
wherein the second portion of the frame comprises: the selected display device.

8. The method of claim 1, wherein mini-map comprises a focus rectangle, and the indication of navigation further comprises a manipulation of the focus rectangle.

9. The method of claim 9, wherein the manipulation of the focus rectangle comprises dragging the focus rectangle.

10. The method of claim 9, wherein the manipulation of the focus rectangle comprises resizing the focus rectangle.

11. The method of claim 1, wherein the indication of manipulation comprises a mouse click in the mini-map.

12. The method of claim 1, further comprising:
determining that a part of the frame outside of the second portion has been updated; and
indicating the update on the mini-map.

13. The method of claim 1, wherein the indication of manipulation comprises a multi-touch gesture.

14. A computer-readable storage medium bearing computer-readable instructions that, when executed on a computer, cause the computer to perform operations comprising:
receiving an indication of a frame of a remoted desktop to display in the remote presentation session;
displaying a first portion of the frame in the viewing area;
generating a mini-map of the frame;
displaying the mini-map;
receiving an indication of navigation of the frame; and
displaying a second portion of the frame in the viewing area, the second portion of the frame corresponding to the indication of navigation.

15. The computer-readable storage medium of claim 13, wherein the indication of navigation comprises a wheel scroll, and the second portion comprises the first portion zoomed in or zoomed out.

16. The computer-readable storage medium of claim 15, wherein the indication of navigation further comprises a button press simultaneous with the wheel scroll.

17. The computer-readable storage medium of claim 16, wherein mini-map comprises a focus rectangle, and the indication of navigation further comprises a manipulation of the focus rectangle.

18. The computer-readable storage medium of claim 17, wherein the manipulation of the focus rectangle comprises dragging the focus rectangle.

19. The computer-readable storage medium of claim 17, wherein the manipulation of the focus rectangle comprises resizing the focus rectangle.

20. The computer-readable storage medium of claim 17, wherein the indication of manipulation comprises a mouse click in the mini-map.
